(19) United States
(12) Patent Application Publication
(10) Pub. No.: US 2025/0232902 A1
(43) Pub. Date: Jul. 17, 2025

(54) COIL COMPONENT

(71) Applicant: Murata Manufacturing Co., Ltd., Kyoto-fu (JP)

(72) Inventors: Hideki KAMO, Nagaokakyo-shi (JP); Yuushi TAKEUCHI, Nagaokakyo-shi (JP); Masaki INUI, Nagaokakyo-shi (JP)

(73) Assignee: Murata Manufacturing Co., Ltd., Kyoto-fu (JP)

(21) Appl. No.: 19/017,089

(22) Filed: Jan. 10, 2025

(30) Foreign Application Priority Data
Jan. 11, 2024 (JP) 2024-002607

(51) Int. Cl. H01F 5/00; H01F 27/29

(52) U.S. Cl. CPC H01F 5/003; H01F 27/292

(57) ABSTRACT

A coil component includes a main body portion including an element body having insulating properties, a coil, and first and second conductor layers electrically connected to the coil. The main body portion has a substantially rectangular parallelepiped shape and has a bottom surface for mounting, a top surface, a pair of end surfaces, a pair of side surfaces, a first ridge portion between the top surface and one of the end surfaces, a second ridge portion between one of the pair of side surfaces and one of the pair of end surfaces, and a third ridge portion between the top surface and one of the pair of side surfaces. The first conductor layer is exposed on part of the bottom surface of the main body portion and on at least part of a first end surface of the pair of end surfaces.

### CROSS-REFERENCE TO RELATED APPLICATION

This application claims benefit of priority to Japanese Patent Application No. 2024-002607, filed Jan. 11, 2024, the entire content of which is incorporated herein by reference.

### BACKGROUND

### Technical Field

The present disclosure relates to a coil component.

### Background Art

Conventionally, as a coil component, for example, there is a multilayer coil component described in Japanese Unexamined Patent Application Publication No. 2018-26454. The multilayer coil component described in Japanese Unexamined Patent Application Publication No. 2018-26454 includes a coil disposed inside an element body having insulating properties. The coil includes, for example, a plurality of coil wiring layers stacked with insulating layers interposed therebetween. These coil wiring layers are electrically connected through via conductors provided in the insulating layers.

### SUMMARY

A large load is imposed on a coil component when the coil component is mounted, for example, and cracking, chipping, or the like may occur in a corner portion of the component. Therefore, there has been a demand for a coil component having excellent shock resistance with respect to an external shock. Japanese Unexamined Patent Application Publication No. 2018-26454 discloses providing a chamfered portion in a corner portion of a coil component having a substantially rectangular parallelepiped shape, for example. Through providing of a chamfered portion in a corner portion of a coil component, cracking, chipping, or the like is unlikely to occur in the vicinity of the corner portion when the coil component is mounted, for example.

However, according to the configuration of Japanese Unexamined Patent Application Publication No. 2018-26454, there is room for improvement in terms of suppressing occurrence of cracking, chipping, or the like in a corner portion while a high degree of freedom in designing a coil is maintained.

Accordingly, the present disclosure provides a coil component capable of further improving shock resistance with respect to an external shock while suppressing a decrease in the degree of freedom in designing a coil.

A coil component according to an aspect of the present disclosure includes a main body portion including an element body having insulating properties, a coil disposed inside the element body, a first conductor layer electrically connected to one end side of the coil, and a second conductor layer electrically connected to another end side of the coil, and the main body portion has a substantially rectangular parallelepiped shape, and has a bottom surface for mounting, a top surface located away from the bottom surface in a height direction orthogonal to the bottom surface of the main body portion, a pair of end surfaces located away from each other in a first direction orthogonal to the height direction, a pair of side surfaces located away from each other in a second direction orthogonal to the height direction and the first direction, a first ridge portion between the top surface and one of the pair of end surfaces, a second ridge portion between one of the pair of side surfaces and one of the pair of end surfaces, and a third ridge portion between the top surface and one of the pair of side surfaces, the first conductor layer is exposed on part of the bottom surface of the main body portion and on at least part of a first end surface of the pair of end surfaces, the second conductor layer is exposed on part of the bottom surface of the main body portion and on at least part of a second end surface of the pair of end surfaces, each of the first ridge portion, the second ridge portion, and the third ridge portion is formed from a curved surface rounded to be curved in a projecting shape, and the first ridge portion has a radius of curvature R1 that is larger than a radius of curvature R2 of the second ridge portion and a radius of curvature R3 of the third ridge portion.

The coil component according to the present disclosure can further improve shock resistance with respect to an external shock while suppressing a decrease in the degree of freedom in designing a coil.

### BRIEF DESCRIPTION OF THE DRAWINGS

FIG. 1 is a schematic perspective view of a coil component according to an embodiment of the present disclosure;

FIG. 2 is a schematic see-through perspective view of the coil component of FIG. 1;

FIG. 3 is a schematic side view of the coil component of FIG. 1 when viewed in a second direction Y;

FIG. 4 is a schematic top view of the coil component of FIG. 1;

FIG. 5 is a schematic end view of the coil component of FIG. 1 when viewed in a first direction X;

FIG. 6 is a graph illustrating a relationship between a radius of curvature of a first ridge portion and an occurrence rate of chipping on a top surface of a coil component;

FIG. 7 is a schematic side view of a coil component of a first modification when viewed in the second direction Y;

FIG. 8 is a schematic top view of the coil component of FIG. 7;

FIG. 9 is a schematic end view of the coil component of FIG. 7 when viewed in the first direction X;

FIG. 10 is a schematic perspective view of a coil component of a second modification;

FIG. 11 is a schematic see-through perspective view of the coil component illustrated in FIG. 10;

FIG. 12A is a schematic view for illustrating a method for measuring a radius of curvature and a schematic end view of the coil component when viewed in the first direction X;

FIG. 12B is a schematic perspective view illustrating a sample for measuring a radius of curvature manufactured from the coil component of FIG. 12A; and

FIG. 12C is a schematic enlarged side view in which part of the sample for measuring a radius of curvature of FIG. 12B is enlarged.

### DETAILED DESCRIPTION

### Findings on which the Present Disclosure is Based

To suppress a decrease in the degree of freedom in designing a coil and improve shock resistance with respect to an external shock of a coil component, the present inventors have conducted intensive study and have obtained the following findings.

In a conventional coil component, usually, a rounded portion (R portion) is formed in each corner portion by barrel polishing (Japanese Unexamined Patent Application Publication No. 2018-26454, or the like). In this case, since a plurality of corner portions of the coil component is rounded in an isotropic manner, as long as each corner portion has the same shape and hardness, the R portion having a substantially equal curvature is usually formed.

The larger the rounded portion (radius of curvature) of the R portion is, the less likely cracking, chipping, or the like is to occur in the corner portion. However, when the radius of curvature of the corner portion becomes larger, the internal capacitance of an element body becomes smaller, and the area inside the element body in which a coil can be formed becomes smaller. Accordingly, for example, the number of turns (the number of stacked layers in the case of a multilayer coil), the shape, the size, or the like of the coil is limited, and thus the degree of freedom in designing the coil may be decreased. As a result, in some cases, desired electric characteristics cannot be obtained.

Therefore, in order to achieve both the electric characteristics and shock resistance with respect to an external shock, the present inventors have independently studied the radius of curvature of a corner portion of a coil component according to the position of the corner portion.

In a coil component, besides a corner portion on a mounting surface side, there are a corner portion (a first ridge portion) between an end surface on which an outer electrode is located and a top surface, a corner portion (a second ridge portion) between a side surface and an end surface, and a corner portion (a third ridge portion) between the top surface and a side surface. Among these ridge portions, the first ridge portion is more likely to be externally shocked than the second ridge portion and the third ridge portion are. For example, when the coil component is mounted, a mounter nozzle is sucked on the first ridge portion between the end surface on which an outer electrode is located and the top surface, a large load is imposed on the first ridge portion. On the other hand, as for the second ridge portion and the third ridge portion, when the radius of curvature is made too large, the degree of freedom in designing the coil may be largely affected. In addition, when the radius of curvature of the second ridge portion is made too large, the outer electrode located on the end surface of the coil component extends over the second ridge portion (on a curved surface) and can be visually recognized from the side surface side. As a result, there is also a problem in which the coil component is determined as a defective product when being sorted by appearance, and yield may be reduced. Therefore, the position or the size of the outer electrode can be restricted.

Based on the new findings described above, the present inventors have found that when a radius of curvature R1 of the first ridge portion is made larger than a radius of curvature R2 of the second ridge portion and a radius of curvature R3 of the third ridge portion, occurrence of cracking or chipping in the coil component can be suppressed while a decrease in the degree of freedom in designing a coil or an outer electrode is suppressed and have reached the following disclosure.

Hereinafter, an embodiment of the present disclosure will be described with reference to the drawings. Note that the present disclosure is not limited by the embodiment. In addition, in the drawings, members that are substantially the same as each other are denoted by the same reference signs. For illustrative purposes, the respective elements in the drawings may be exaggeratedly illustrated and are not necessarily consistent with the scales.

In addition, in the following description, for convenience of explanation, terms indicating directions such as “up”, “down”, “right”, “left”, and “side” are used on the assumption of a normal use state, but do not indicate limiting a use state or the like of the coil component according to the present disclosure.

In the figures described below, for reference, an X axis, a Y axis, and a Z axis orthogonal to each other are schematically indicated. The Z axis corresponds to a height direction of the coil component when a surface of the coil component on a mounting side is a bottom surface.

### EMBODIMENT

### Overview of Coil Component

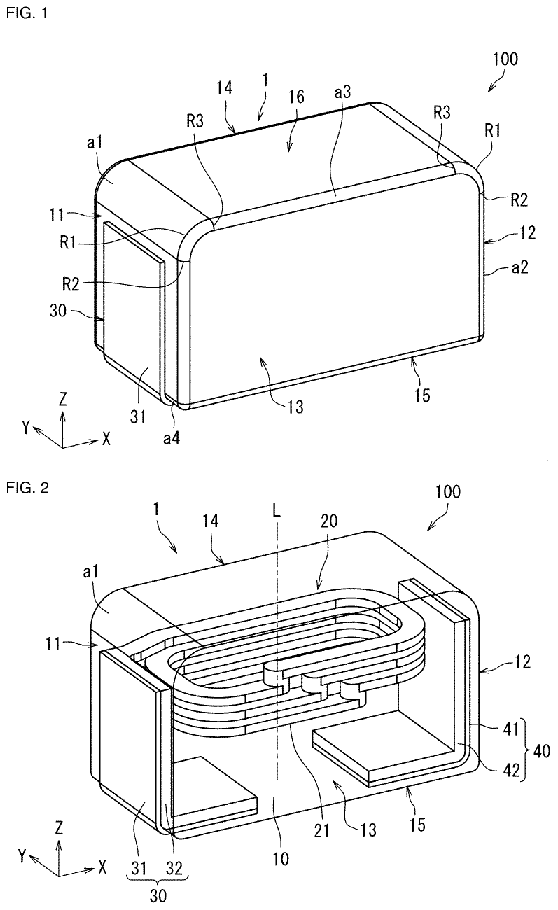

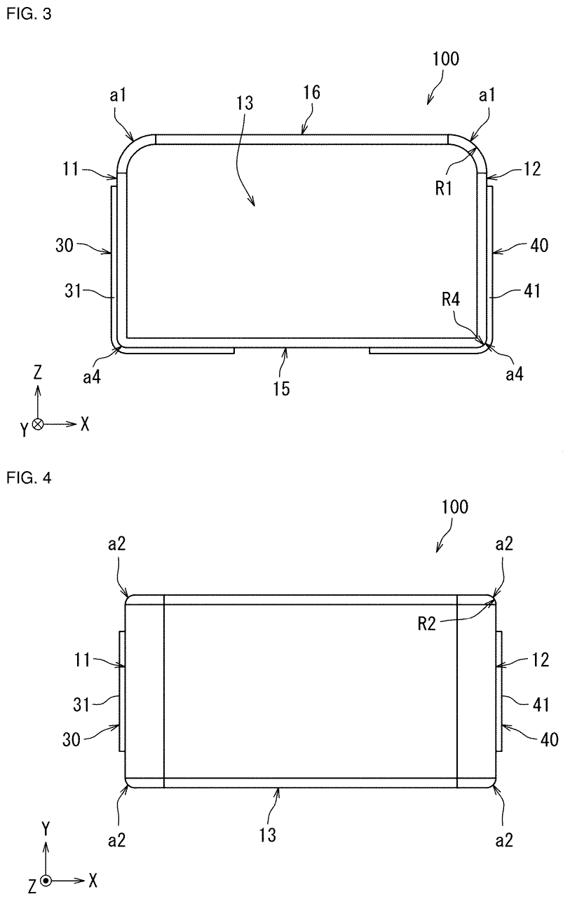

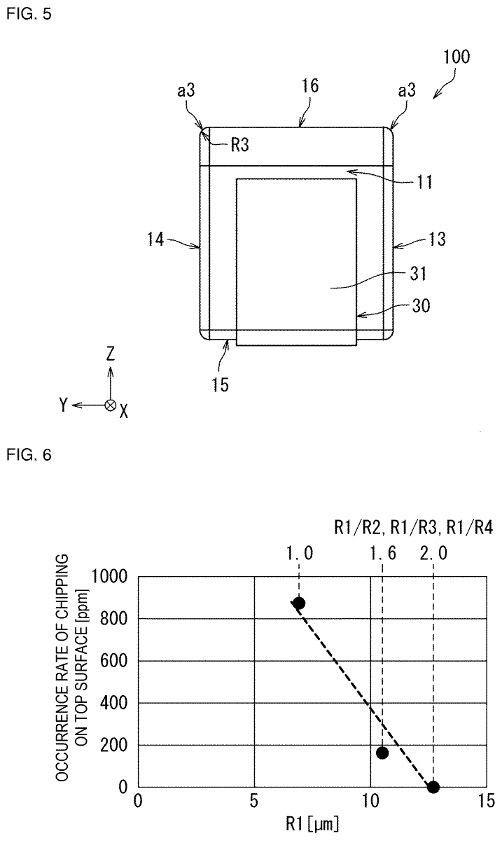

FIG. 1 is a schematic perspective view illustrating an embodiment of a coil component. FIG. 2 is a see-through perspective view of the coil component illustrated in FIG. 1. FIG. 3 is a side view of the coil component of FIG. 1 when viewed in a second direction Y. FIG. 4 is a top view of the coil component of FIG. 1. FIG. 5 is an end view of the coil component of FIG. 1 when viewed in a first direction X.

As illustrated in FIGS. 1 and 2, a coil component 100 includes a main body portion 1, a first electrode layer 31, and a second electrode layer 41 disposed on surfaces of the main body portion 1. The coil component 100 is electrically connected to a wiring line of a circuit board (not illustrated) through the first electrode layer 31 and the second electrode layer 41.

The main body portion 1 has a substantially rectangular parallelepiped shape, for example. The “substantially rectangular parallelepiped” includes a rectangular parallelepiped having rounded corner portions and/or rounded ridge portions.

The main body portion 1 has a bottom surface 15 for mounting, a top surface 16 located away from the bottom surface 15 in a height direction Z (hereinafter, referred to as a “Z direction”) of the main body portion 1, a pair of end surfaces 11 and 12, and a pair of side surfaces 13 and 14. The end surfaces 11 and 12 are located away from each other in the first direction X orthogonal to the Z direction. The side surfaces 13 and 14 are located away from each other in the second direction Y orthogonal to the height direction Z and the first direction X. In the illustrated example, the main body portion 1 has a rectangular parallelepiped shape elongated in the X direction. That is, a width of each of the side surfaces 13 and 14 in the first direction X is larger than a width of each of the end surfaces 11 and 12 in the second direction Y. The coil component 100 is mounted on a circuit board or the like such that the bottom surface 15 side faces a mounting surface.

As illustrated in FIG. 2, the main body portion 1 includes an element body 10 having insulating properties, a coil 20 located inside the element body 10, a first conductor layer 32, and a second conductor layer 42.

The element body 10 has, for example, a structure in which a plurality of insulating layers is stacked. In the example illustrated in FIG. 2, a stacking direction of the insulating layers is a direction (the height direction Z) orthogonal to the bottom surface 15 and the top surface 16. In the present specification, being “orthogonal” need only be practically orthogonal and includes a case of being substantially orthogonal considering a realistic variation range. In the illustrated example, the element body 10 is exposed on part of surfaces of the main body portion 1 (for example, portions in which the first electrode layer 31 and the second electrode layer 41 are not disposed).

The element body 10 is formed using a photosensitive material (an insulating paste) including a filler material and a glass material. The element body 10 may be a fired product of such an insulating paste. The element body 10 after being fired may contain a glass component and a filler component. Note that in the element body 10, a plurality of insulating layers is integrated by firing, and in some cases, boundaries between the insulating layers are not clear.

The coil 20 includes a conductive material such as Ag, Cu, and Au. The coil 20 may be composed of, for example, a conductive material and glass particles. The coil 20 is helically wound in the stacking direction of the insulating layers. In the example illustrated in FIG. 2, an axial direction L of the coil 20 is orthogonal to the top surface 16. That is, the coil 20 is disposed so as to be wound in the height direction Z (vertically wound). The “axial direction L” is parallel to a central axis of a helical shape along which the coil 20 is wound.

The coil 20 includes a plurality of coil wiring layers 21 disposed away from each other in the axial direction L and a connection conductor (a via conductor) disposed between two of the coil wiring layers 21 adjacent to each other. In this manner, the plurality of coil wiring layers 21 is electrically connected to each other in series with a corresponding connection conductor interposed therebetween and constitutes the coil 20 having a helical shape, for example.

The first conductor layer 32 and the second conductor layer 42 are composed of, for example, the same conductive material as the coil 20. The first conductor layer 32 and the second conductor layer 42 may be integrally formed with the coil 20, or may be composed of materials different from each other.

The first conductor layer 32 is electrically connected to one end side of the coil 20. The second conductor layer 42 is electrically connected to another end side of the coil 20. The first conductor layer 32 constitutes a first outer electrode 30 together with the first electrode layer 31. The second conductor layer 42 constitutes a second outer electrode 40 together with the second electrode layer 41. Note that in this example, each outer electrode includes a conductor layer located inside the main body and an electrode layer disposed on a surface of the main body portion, but the outer electrode need only include at least a conductor layer.

In the example illustrated in FIG. 2, the first conductor layer 32 is connected to, for example, the coil wiring layer 21 located highest in the coil 20. The first conductor layer 32 extends along at least part of the end surface 11 from part of the bottom surface 15. In a side view from the side surface 13 side, the first conductor layer 32 may form a substantially L shape. The first conductor layer 32 is exposed on a surface of the main body portion 1. Here, the first conductor layer 32 is exposed on part of the bottom surface 15 of the main body portion 1 and on at least part of the end surface 11. The portion of the first conductor layer 32 exposed on the bottom surface 15 and the portion of the element body 10 (insulator) exposed on the bottom surface 15 are flush with each other. In addition, the portion of the first conductor layer 32 exposed on the end surface 11 and the portion of the element body 10 exposed on the end surface 11 are flush with each other.

The second conductor layer 42 is connected to, for example, the coil wiring layer 21 located lowest in the coil 20. The second conductor layer 42 extends along at least part of the end surface 12 from part of the bottom surface 15. In a side view from the side surface 14 side, the second conductor layer 42 may form a substantially L shape. The second conductor layer 42 is exposed on a surface of the main body portion 1. Here, the second conductor layer 42 is exposed on part of the bottom surface 15 of the main body portion 1 and on at least part of the end surface 12. The portion of the second conductor layer 42 exposed on the bottom surface 15 and the portion of the element body 10 exposed on the bottom surface 15 are flush with each other. In addition, the portion of the second conductor layer 42 exposed on the end surface 12 and the portion of the element body 10 having insulating properties exposed on the end surface 12 are flush with each other.

The shape of the coil 20 is not limited to the example illustrated in FIG. 2. In FIG. 2, although the coil 20 forms a substantially oval shape when viewed in the axial direction L, the shape of the coil 20 viewed in the axial direction L is not limited to an oval and may be a circle, an ellipse, a rectangle, other polygons, or the like. In addition, the number of coil wiring layers 21 constituting the coil 29 is also not limited to the illustrated number. For example, in FIG. 2, the number of coil wiring layers 21 may be further increased, and in this case, the coil wiring layer 21 of the bottom layer may be located near the bottom surface 15.

The first electrode layer 31 and the second electrode layer 41 contain, for example Ni and Sn. The first electrode layer 31 and the second electrode layer 41 may have a stacked structure including an Sn layer and an Ni layer located on the main body portion 1 side of the Sn layer. The Sn layer and the Ni layer may be plating layers.

The first electrode layer 31 is electrically connected to the first conductor layer 32. In the example illustrated in FIG. 2, the first electrode layer 31 extends over at least part of the end surface 11 from part of the bottom surface 15 of the main body portion 1. The first electrode layer 31 is disposed on portions of the first conductor layer 32 exposed on the end surface 11 and on the bottom surface 15. The first electrode layer 31 may cover the exposed portions of the first conductor layer 32. The first electrode layer 31 forms a substantially L shape in a side view from the side surface 13 side.

The second electrode layer 41 is electrically connected to the second conductor layer 42. In the example illustrated in FIG. 2, the second electrode layer 41 extends over at least part of the end surface 12 from part of the bottom surface 15 of the main body portion 1. The second electrode layer 41 is disposed on portions of the second conductor layer 42 exposed on the end surface 12 and on the bottom surface 15. The second electrode layer 41 may cover the exposed portions of the second conductor layer 42. The second electrode layer 41 forms a substantially L shape in a side view from the side surface 14 side.

### Radius of Curvature in Ridge Portion of Main Body Portion

Subsequently, a radius of curvature of a corner portion (a ridge portion) of the coil component 100 will be described.

As illustrated in FIGS. 1 to 5, the coil component 100 includes a plurality of ridge portions each located between two adjacent surfaces. Each ridge portion connects two adjacent surfaces. The plurality of ridge portions includes a first ridge portion a1 to a fourth ridge portion a4. The first ridge portion a1 includes two ridge portions between the top surface 16 and each of the end surfaces 11 and 12. The second ridge portion a2 includes two ridge portions between the side surface 13 and each of the end surfaces 11 and 12, and two ridge portions between the side surface 14 and each of the end surfaces 11 and 12. The third ridge portion a3 includes two ridge portions between the top surface 16 and each of the side surfaces 13 and 14. The fourth ridge portion a4 includes two ridge portions between the bottom surface 15 and each of the end surfaces 11 and 12.

The first ridge portion a1, the second ridge portion a2, and the third ridge portion a3 include, for example, an insulating portion, which is the element body 10. At least part of the fourth ridge portion a4 includes the first conductor layer 32 or the second conductor layer 42.

Each of the first ridge portion a1, the second ridge portion a2, and the third ridge portion a3 is formed from a curved surface rounded to be curved in a projecting shape. The “curved surface” need only have a substantially semi-circular shaped cross section (whose radius of curvature is measurable) and may include fine unevenness or steps generated during processing such as barrel polishing or blasting. In the example illustrated in FIGS. 1 to 5, the radii of curvature R1 of the two first ridge portions a1 are configured to be substantially equal to each other. Similarly, the radii of curvature R2 of the four second ridge portions a2 are configured to be substantially equal to each other, and the radii of curvature R3 of the two third ridge portions a3 are configured to be substantially equal to each other.

The radius of curvature R1 of each first ridge portion a1 is larger than the radius of curvature R2 of each second ridge portion a2 and the radius of curvature R3 of each third ridge portion a3 (R1>R2 and R1>R3). The radius of curvature R1 is, for example, equal to or more than two times the radii of curvature R1 and R3.

In addition, the radius of curvature R2 of the second ridge portion a2 and the radius of curvature R3 of the third ridge portion a3 are configured to be, for example, substantially the same (R2=R3).

The fourth ridge portion a4 is also formed from a curved surface rounded to be curved in a projecting shape. The radius of curvature R4 of the fourth ridge portion a4 is smaller than the radius of curvature R1 (R1>R4). As illustrated in FIGS. 1 to 5, the radius of curvature R4 may be smaller than the radii of curvature R2 and R3.

### Results of Studies and Experiments

The present inventors have studied influences of the radii of curvature R1 to R3 on the occurrence of chipping on the top surface, and the results will be described.

FIG. 6 is the experiment results illustrating a relationship between the radius of curvature R1 of the first ridge portion a1 and an occurrence rate of chipping on the top surface 16 of the coil component 100. Here, samples A to C in which the main body portion 1 has a rectangular parallelepiped shape (0.4 mm×0.2 mm×0.2 mm), and the radii of curvature R1 to R4 of the main body portion 1 are set as shown in Table 1 are used. A mounter nozzle (leading end shape: 0.3 mm×0.15 mm) is inserted into the top surface side (in the vicinity of the first ridge portion) of each sample by 0.7 mm so that a predetermined load is applied, and an occurrence rate of chipping on the top surface is obtained.

TABLE 1

| | R1 | R2 | R3 | R4 | R1/R2, R1/R3. R1/R4 |
|---|---|---|---|---|---|
| Sample | [μm] | [μm] | [μm] | [μm] | [—] |
| A | 6.5 | 6.5 | 6.5 | 6.5 | 1.0 |
| B | 10.5 | | | | 1.6 |
| C | 13.0 | | | | 2.0 |

From the results illustrated in FIG. 6, even when the radii of curvature R2 to R4 are constant, when the radius of curvature R1 is increased, the occurrence of chipping on the top surface can be suppressed. Therefore, it is confirmed that the strength on the top surface side can be improved without increasing the radii of curvature R2 to R4 more than necessary.

In addition, the results illustrated in FIG. 6 shows that the larger the radius of curvature R1 is with respect to the radii of curvature R2 to R4, the smaller the occurrence rate of chipping becomes, and when the radius of curvature R1 is approximately two times the radii of curvature R2 to R4, chipping does not occur on the top surface. As a result, it has been found that the occurrence of chipping on the top surface can be remarkably suppressed when the radius of curvature R1 is, for example, equal to or more than two times the radii of curvature R2 to R4.

### Effects

The coil component 100 of the present embodiment includes the main body portion 1 including the coil 20. The main body portion 1 further includes the first conductor layer 32 exposed on part of the bottom surface 15 of the main body portion 1 and on at least part of the end surface 11 and the second conductor layer 42 exposed on part of the bottom surface 15 of the main body portion 1 and on at least part of the end surface 12. In the main body portion 1, each of the first ridge portion a1 between the top surface 16 and one of the pair of end surfaces 11 and 12, the second ridge portion a2 between one of the pair of side surfaces 13 and 14 and one of the pair of end surfaces 11 and 12, and the third ridge portion a3 between the top surface 16 and one of the pair of side surfaces 13 and 14 is formed from a curved surface rounded to be curved in a projecting shape. The radius of curvature R1 of the first ridge portion a1 is larger than the radius of curvature R2 of the second ridge portion a2 and the radius of curvature R3 of the third ridge portion a3.

According to the above-described configuration, since the radius of curvature R1 of the first ridge portion a1 on which a load is likely to be imposed at the time of mounting is made larger than the radii of curvature R2 and R3, occurrence of cracking, chipping, or the like of the main body portion 1 can be suppressed. In addition, since the radii of curvature R2 and R3 are made small, a decrease in internal capacitance (volume of an area in which the coil 20 can be formed) of the main body portion 1 can be suppressed. Therefore, the shock resistance with respect to an external shock of the coil component 100 can be improved while a decrease in the degree of freedom in designing the coil 20 is suppressed.

Note that in the present specification, a case where a radius of curvature of a ridge portion has (satisfies) a predetermined magnitude relationship includes not only a case where the radii of curvature of all the ridge portions of the main body portion satisfy the magnitude relationship, but also a case where the radii of curvature of some of the ridge portions satisfy the relationship. For example, as long as at least one of the first ridge portions a1 has a radius of curvature larger than one of the second ridge portions a2 and one of the third ridge portions a3, the above-described effects can be obtained. However, when the radii of curvature R1 of the two first ridge portions a1 are both larger than the radii of curvature R2 and R3 of all of the second ridge portions a2 and the third ridge portions a3, occurrence of cracking, chipping, or the like can be more effectively suppressed.

According to the present embodiment, the radius of curvature R1 of each first ridge portion a1 and the radius of curvature R2 of each second ridge portions a2 satisfy R1/R2≥2. Alternatively, the radius of curvature R1 of the first ridge portion a1 and the radius of curvature R3 of each third ridge portion a3 satisfy R1/R3≥2. With such a configuration, occurrence of cracking, chipping, or the like in a corner portion (the first ridge portion a1) of the coil component 100 can be more effectively suppressed while a decrease in the degree of freedom in designing the coil 20 is suppressed (see FIG. 6).

The radii of curvature R1 to R3 may be configured to satisfy R1/R2≥2 and R1/R3≥2. With such a configuration, occurrence of cracking, chipping, or the like in a corner portion (the first ridge portion a1) of the coil component 100 can be more effectively suppressed while the degree of freedom in designing the coil 20 is maintained high (see FIG. 6).

According to the present embodiment, the radius of curvature R2 of the second ridge portion a2 and the radius of curvature R3 of the third ridge portion a3 are configured to be the same (R2=R3). According to such a configuration, the second ridge portion a2 and the third ridge portion a3 can be simultaneously formed by the same processing step (for example, barrel finishing). Therefore, the main body portion 1 can be more easily manufactured. Note that a case in which the radius of curvature R2 of the second ridge portion a2 and the radius of curvature R3 of the third ridge portion a3 are “the same” or “configured to be the same” is sufficient as long as the radii of curvature R2 and R3 are designed to be the same and includes an error within +5 percent considering a realistic manufacturing variation.

According to the present embodiment, in the main body portion 1, the fourth ridge portion a4 between the bottom surface 15 and one of the pair of end surfaces 11 and 12 is formed from a curved surface rounded to be curved in a projecting shape. The radius of curvature R4 of the fourth ridge portion a4 is smaller than, for example, the radius of curvature R1 of the first ridge portion a1, the radius of curvature R2 of the second ridge portion a2, and the radius of curvature R3 of the third ridge portion a3. According to such a configuration, as described below, occurrence of chip standing can be suppressed.

When the radius of curvature R4 of the fourth ridge portion a4 is too large, at the time of mounting, on the bottom surface 15 of the coil component 100, solder wettability is likely to become non-uniform between the first outer electrode 30 and the second outer electrode 40, and the mounting surface, as a result of which chip standing (tombstone phenomenon) in which the coil component 100 is mounted in an inclined manner easily occurs. Therefore, when the radius of curvature R4 of the fourth ridge portion a4 is made smaller than, for example, the radii of curvature R1 to R3, occurrence of chip standing can be suppressed. In addition, in the illustrated example, since at least part of the fourth ridge portion a4 is covered with the first electrode layer 31 or the second electrode layer 41, cracking or chipping due to an external shock is unlikely to occur in the fourth ridge portion a4. Therefore, even when the radius of curvature R4 of the fourth ridge portion a4 is made smaller than the radii of curvature R1 to R3, the shock resistance with respect to an external shock of the coil component 100 can be ensured.

According to the present embodiment, the first conductor layer 32 is exposed on at least part of the end surface 11 and on part of the bottom surface 15 and constitutes at least part of the fourth ridge portion a4. Similarly, the second conductor layer 42 electrically connects the second electrode layer 41 and the other end side of the coil 20. The second conductor layer 42 is exposed on at least part of the end surface 12 and on part of the bottom surface 15 and constitutes at least part of the fourth ridge portion a4. According to such a configuration, since at least part of each fourth ridge portion a4 includes the first conductor layer 32 or the second conductor layer 42 including a relatively hard conductive material, occurrence of cracking, chipping, or the like in the fourth ridge portion a4 can be suppressed. Moreover, through disposing of the first electrode layer 31 or the second electrode layer 41 over the fourth ridge portion a4, the fourth ridge portion a4 can be protected from an external shock.

In the coil component 100 of the present embodiment, the coil 20 includes the plurality of coil wiring layers 21 stacked in the axial direction L. According to such a configuration, when the radii of curvature R2 and R3 are made small, the degree of freedom in designing the shape, the size, or the like of the coil wiring layers 21 can be increased.

### First Modification

A coil component of a first modification is different from the coil component 100 illustrated in FIGS. 1 to 5 in that the radius of curvature R2 and the radius of curvature R3 are different from each other.

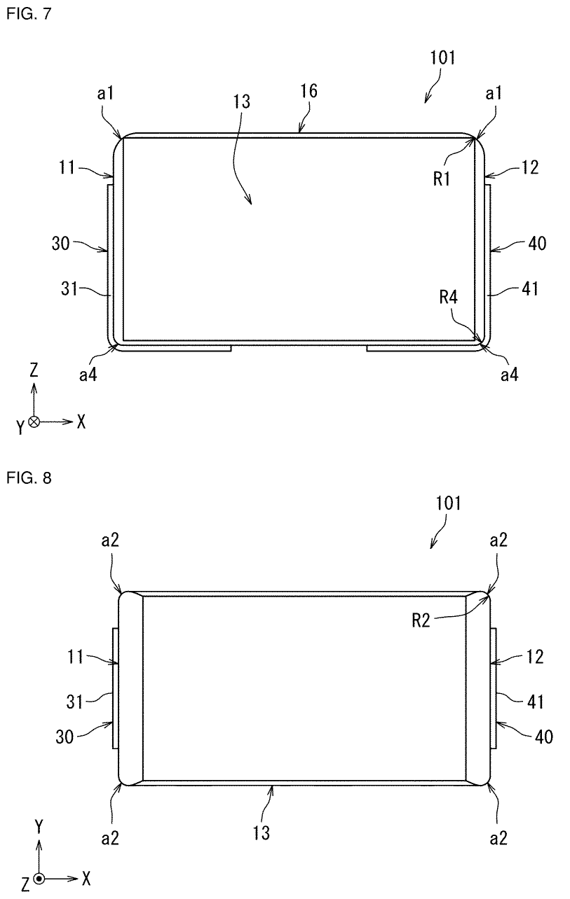

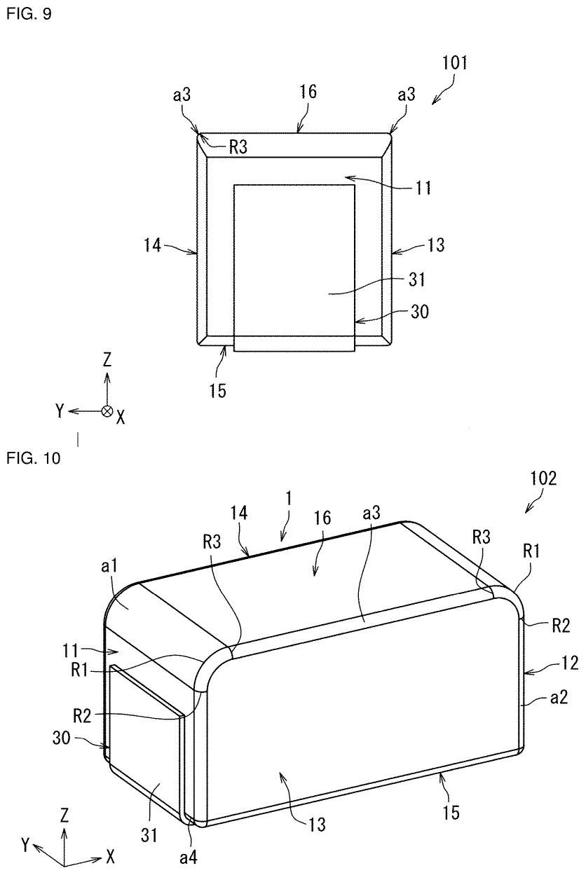

FIG. 7 is a side view of the coil component of the first modification when viewed in the second direction Y. FIG. 8 is a top view of the coil component of FIG. 7. FIG. 9 is an end view of the coil component of FIG. 7 when viewed in the first direction X.

In a coil component 101 illustrated in FIGS. 7 to 9, the radius of curvature R2 of the second ridge portion a2 is larger than the radius of curvature R3 of the third ridge portion a3 (R1>R2>R3).

According to such a configuration, since the radius of curvature R3 is made small, suction leakage is unlikely to occur during suction by a mounter nozzle, and occurrence of mounting failure can be suppressed.

Moreover, when the coil 20 is disposed to be vertically wound (so that the axial direction L is orthogonal to the top surface 16) (FIG. 2), as described below, setting each radius of curvature such that R2>R3 is satisfied makes the effects more advantageous.

When the vertically wound coil 20 is disposed inside the main body portion 1, in a case where the radius of curvature R3 of the second ridge portion a2 is large, the area of a cross section near the top surface 16 of the main body portion 1 parallel to the top surface 16 becomes small. Therefore, in some cases, for example, the inner diameter of the coil 20 (or the coil wiring layers 21) cannot be made sufficiently large, or the coil wiring layers 21 cannot be stacked near the top surface 16. On the other hand, when the radius of curvature R3 is made smaller than the radius of curvature R2, the shape or the size of the coil 20 (or the coil wiring layers 21) or the number of stacked layers of the coil wiring layers 21 is less restricted. Therefore, the degree of freedom in designing the vertically wound coil 20 can be improved. As a result, the strength of the coil component can be further increased while desired electric characteristics of the coil component are ensured.

Note that the width of the respective ridge portions a1 to a3 (the width of R portion) may be appropriately adjusted such that the ridge portions a1 to a3 have desired radii of curvature R1 to R3, respectively.

### Another Coil Component of First Modification

The radius of curvature R3 of the third ridge portion a3 may be larger than the radius of curvature R2 of the second ridge portion a2 (R1>R3>R2).

According to such a configuration, since the radius of curvature R3 located on the top surface 16 side is made large, an external shock due to a load imposed on the top surface 16 side can be easily mitigated, and chipping or the like that occurs on the top surface 16 can be more effectively suppressed.

In addition, since the radius of curvature R2 is made small, the width of a flat portion (a portion that is not curved) of each of the end surfaces 11 and 12 becomes large in the Y direction, and thus each of the entire first outer electrode 30 and the entire second outer electrode 40 can be more reliably disposed on the flat portion. Therefore, extension of each of the first outer electrode 30 (the first electrode layer 31 or the first conductor layer 32) and the second outer electrode 40 (for example, the second electrode layer 41 or the second conductor layer 42) over the second ridge portion a2 that is curved and visual recognition of the first outer electrode 30 and the second outer electrode 40 can be suppressed. As a result, reduction in yield can be suppressed. In addition, the degree of freedom of the size or the position of the first outer electrode 30 and the second outer electrode 40 can be improved.

Moreover, in the present modification, the first electrode layer 31 is provided so as to cover the portions of the first conductor layer 32 exposed on the end surface 11 and on the bottom surface 15 of the main body portion 1, and the second electrode layer 41 is provided so as to cover the portions of the second conductor layer 42 exposed on the end surface 12 and on the bottom surface 15 of the main body portion 1. With such a configuration, problems such as corrosion of surfaces of the conductor layers 32 and 42 and solder leaching of the conductor layers 32 and 42 at the time of mounding (soldering) can be suppressed while reduction in yield due to visual recognition of the electrode layers 31 and 41 is suppressed.

### Second Modification

A coil component of a second modification is different from the coil component 100 illustrated in FIGS. 1 to 5 in that a coil is disposed (horizontally wound) such that the axial direction Lis orthogonal to the pair of side surfaces (here, parallel to the top surface). In the present specification, being “parallel” need only be practically parallel and includes a case of being substantially parallel considering a realistic variation range.

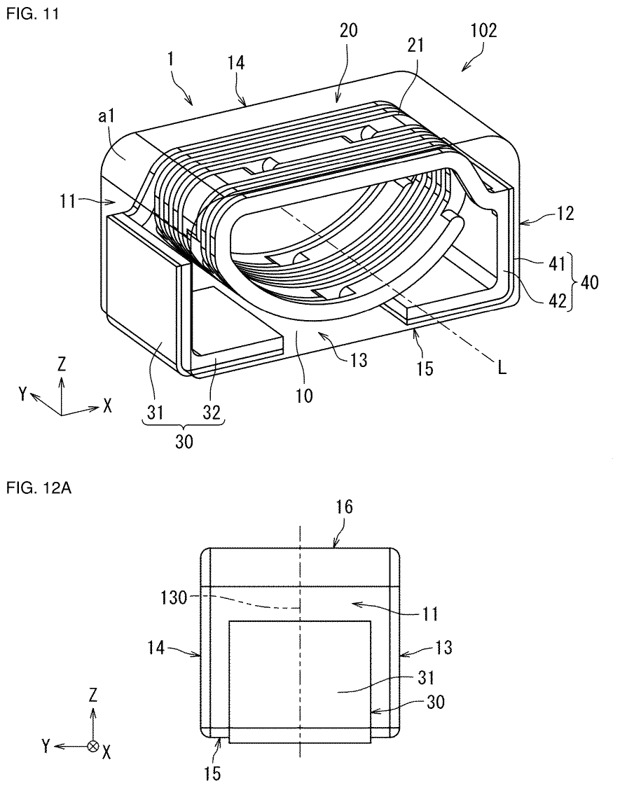

FIG. 10 is a schematic perspective view of a coil component of the second modification. FIG. 11 is a schematic see-through perspective view of the coil component illustrated in FIG. 10.

As illustrated in FIG. 11, in a coil component 102, the coil 20 includes the plurality of coil wiring layers 21 stacked in a direction from the side surface 14 to the side surface 13. The stacking direction is parallel to the second direction Y. The axial direction L of the coil 20 is the same as the stacking direction and is parallel to the top surface 16. The first conductor layer 32 and the second conductor layer 42 can be electrically connected to end portions of the coil 20 at positions lower than those of a vertically wound coil component. Therefore, in the example illustrated in FIGS. 10 and 11, the heights of the first conductor layer 32 and the second conductor layer 42 in the Z direction and the heights of the first electrode layer 31 and the second electrode layer 41 are lower than those of the coil component 100 illustrated in FIGS. 1 and 2. Note that the shape, the arrangement, or the like of these electrodes are not particularly limited to the illustrated examples.

The radii of curvature R1 to R4 of the main body portion 1 of the coil component 102 are set to satisfy, for example, the same relationship as the coil component 100 of FIGS. 1 to 5 (R1>R2=R3).

### Third Modification

A coil component of a third modification has a horizontally wound coil. The coil component of the third modification is different from the coil component 102 of the second modification illustrated in FIGS. 10 and 11 in that the radius of curvature R2 and the radius of curvature R3 are different from each other.

In the present modification, the radius of curvature R1 of the first ridge portion a1 is larger than the radius of curvature R2 of the second ridge portion a2 and the radius of curvature R3 of the third ridge portion a3, and the radius of curvature R2 of the second ridge portion a2 is larger than the radius of curvature R3 of the third ridge portion a3 (R1>R2>R3).

When the coil 20 is disposed to be horizontally wound, as described below, setting each radius of curvature such that R2>R3 is satisfied makes the effects more advantageous.

When the horizontally wound coil 20 is disposed inside the main body portion 1, in a case where the radius of curvature R3 is large, the cross section (a YZ cross section) of the main body portion 1 parallel to the end surface 11 has a shape in which two corner portions on the top surface 16 side are largely missing. Therefore, in some cases, the inner diameter of the coil 20 cannot be made sufficiently large, and the predetermined number of stacked layers of the coil wiring layers cannot be disposed. On the other hand, according to the present modification, since the radius of curvature R3 is made small, the degree of freedom in designing the horizontally wound coil 20 can be improved, and the inner diameter of the coil 20 and the number of stacked layers can be increased. Therefore, the strength of the coil component can be further increased while desired electric characteristics of the coil component are ensured.

### Another Coil Component of Third Modification

The radius of curvature R3 of the third ridge portion a3 may be made larger than the radius of curvature R2 of the second ridge portion a2 (R1>R3>R2).

According to such a configuration, since the radius of curvature R3 located on the top surface 16 side is made large, an external shock due to a load imposed on the top surface 16 side can be easily mitigated, and chipping or the like that occurs on the top surface 16 can be more effectively suppressed. On the other hand, since the radius of curvature R2 is made small, extension of each of the first electrode layer 31 disposed on the end surface 11 (or the first conductor layer 32 exposed on the end surface 11) and the second electrode layer 41 disposed on the end surface 12 (or the second conductor layer 42 exposed on the end surface 12) over the second ridge portion a2 that is curved and visual recognition of the first electrode layer 31 and the second electrode layer 41 can be suppressed. As a result, reduction in yield can be suppressed. In addition, the degree of freedom of the size or the position of the first outer electrode 30 and the second outer electrode 40 can be improved.

### Method for Manufacturing Coil Component

The coil components 100 to 102 can be manufactured by the following method, for example.

### Step 1

First, an insulating paste layer for an outer layer serving as an outer layer (that is, being exposed on a surface of the main body portion) is formed through repeated spreading by screen printing of an insulating paste having a borosilicate glass as a primary component on a base material such as a carrier film.

### Step 2

Subsequently, a photosensitive conductive paste having Ag as a primary metal component is spread on the insulating paste for an outer layer by screen printing so as to form a photosensitive conductive paste layer. Thereafter, a coil wiring layer and a conductor portion serving as a conductor layer of an outer electrode are simultaneously formed from the photosensitive conductive paste layer by photolithography.

### Step 3

The photosensitive insulating paste is spread by screen printing so as to cover the coil wiring layer and the outer conductor layer and thus form an insulating paste layer. Thereafter, a via hole through which part of the coil wiring layer is exposed and an opening portion through which the conductor portion is exposed are formed in the insulating paste layer by photolithography.

### Step 4

The photosensitive conductive paste is spread by, for example, screen printing on the insulating paste layer and inside the opening portion and the via hole of the insulating paste so as to form a photosensitive conductive paste layer. Thereafter, a connection conductor (a via conductor) located inside the via hole and a conductor portion located inside an opening are formed from the photosensitive conductive paste layer by photolithography.

Through repeating of step 3 and step 4, a coil in which coil wiring layers are helically connected with insulating paste layers interposed therebetween and a conductor layer (an inside portion of an outer electrode) in which conductor portions of the respective layers are integrated are formed. Note that at least the bottom layer and the top layer of the coil wiring layers are pattern-formed so as to be connected to the conductor portions. Thereafter, an insulating layer for an outer layer is formed as the top layer by the same method as step 1 and thus a mother multilayer body is obtained.

### Step 5

The obtained mother multilayer body is cut into a plurality of unfired green multilayer body chips (cutting) with a dicing machine or the like, for example. At this time, the conductor layer is exposed on a cut surface of a corresponding one of the green multilayer body chips.

### Step 6

The unfired green multilayer body chip is fired under predetermined conditions so that a multilayer body chip (a fired product) is obtained. As a result, the portion formed from the insulating paste becomes an insulating portion (element body) containing a glass component. The multilayer body chip has a rectangular parallelepiped shape having an element body, and a coil and a conductor layer embedded in the element body and corresponds to the main body portion 1 illustrated in FIG. 2.

### Step 7

Subsequently, barrel finishing (barrel polishing) is performed on the multilayer body chip. Since the conductor layer is harder than the insulating portion, in the fourth ridge portion a4 including the conductor layer, a chamfered amount by barrel finishing is small. Therefore, in the multilayer body chip after barrel finishing, the radius of curvature R4 of the fourth ridge portion a4 is smaller than the radii of curvature R1 to R3 of the ridge portions a2 to a4 including the insulating portion. The radii of curvature R1 to R3 of the first ridge portion a1 to the third ridge portion a3 are substantially the same.

### Step 8

Subsequently, the first ridge portion a1 is processed such that the radius of curvature R1 of the first ridge portion a1 is made larger than the radius of curvature R2 of the second ridge portion a2 and the radius of curvature R3 of the third ridge portion a3. The processing method is not particularly limited, but laser processing, blasting, or the like can be adopted. Note that the first ridge portion a1 may be processed before barrel finishing (between step 6 and step 7) or before firing of the green multilayer body chip (between step 5 and step 6).

When the radius of curvature R2 and the radius of curvature R3 are made different from each other, for example, before or after processing of the first ridge portion a1, processing (laser processing, blasting, or the like) for making a radius of curvature large may be further performed on the second ridge portion a2 or the third ridge portion a3.

### Step 9

Subsequently, the electrode layers 31 and 41 are formed on portions of the conductor layers 32 and 42 exposed on surfaces of the multilayer body chip (the main body portion 1). The method for forming the electrode layers 31 and 41 is not particularly limited. For example, after Ni plating having a thickness of 2 μm to 10 μm is performed, Sn plating having a thickness of 2 μm to 10 μm may be performed on the Ni plating so that the electrode layers 31 and 41 including an Ni layer and an Sn layer are formed. In this manner, for example, the coil component 100 having a size of 0.4 mm×0.2 mm×0.2 mm is manufactured.

### Method for Measuring Radius of Curvature

The radius of curvature of each ridge portion can be measured by, for example, the following method. Here, a method for measuring the radius of curvature R1 is described as an example, but the same method can be adopted to measure the radii of curvature R2 to R4.

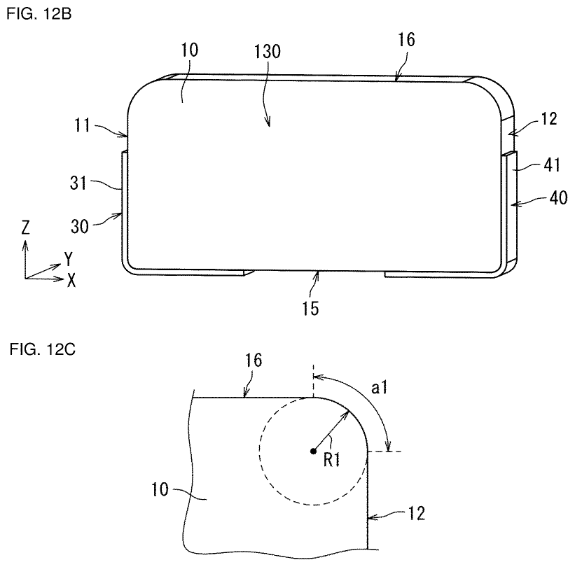

FIGS. 12A to 12C are each a schematic view illustrating a method for measuring a radius of curvature. FIG. 12A is an end view of the coil component 100 when viewed in the first direction X. FIG. 12B is a perspective view illustrating a sample for measuring a radius of curvature manufactured from the coil component 100 of FIG. 12A. FIG. 12C is an enlarged side view in which part of the sample for measuring a radius of curvature of FIG. 12B is enlarged.

First, as illustrated in FIGS. 12A and 12B, the coil component is processed, and a surface 130 parallel to the side surfaces 13 and 14 is exposed so that the sample for measuring a radius of curvature is manufactured. For example, the coil component 100 may be polished in the second direction Y from the side surface 13 side until the thickness of the coil component 100 in the second direction Y becomes, for example, approximately half. Subsequently, as illustrated in FIG. 12C, among the corner portions of the surface 130 having a rectangular shape, the radius of curvature is measured for one or both of the two corner portions located in an upper portion of the surface 130. For example, an image of a portion near a corner portion of the surface 130 is captured by a shape analysis laser microscope (“VK-X1000” manufactured by KEYENCE), and the obtained image is analyzed using a multi-analysis application. Here, the radius of curvature R1 of the corner portion is measured from the above-described image using a radius measuring tool.

Note that the present disclosure is not limited to the above-described embodiment, and various changes in design are conceivable without departing from the gist of the present disclosure. For example, the shapes, the arrangements, the number (the number of stacked layers), the materials, or the like of the coil wiring layers, the connection conductors, and the outer electrodes of the coil component are not limited to the examples illustrated in FIGS. 1 to 11. For example, in the examples illustrated in FIGS. 2, 8, or the like, the coil 20 has a configuration in which a plurality of coil wiring layers, of which the number of turns is less than one, is stacked, but the number of turns of the coil wiring layers may be equal to or more than one. That is, each coil wiring layer may have a flat spiral shape. Moreover, the coil does not have to have a stacked structure. In addition, the structure of the outer electrodes is also not limited to the illustrated examples. The first conductor layer and the second conductor layer need only be disposed so as to be exposed on at least part of an end surface of the main body portion or on part of the bottom surface and does not have to have the illustrated L shape. Similarly, the first electrode layer and the second electrode layer need only be each disposed on a surface of the main body portion and be electrically connected to the first conductor layer and the second conductor layer, respectively, and do not have to have the illustrated L shape. For example, the first electrode layer and the second electrode layer may cover only part of the corresponding conductor layer. Moreover, each outer electrode need only include a conductor layer located inside the main body portion and does not have to include an electrode layer (for example, a plating layer) on a surface of the main body portion.

The above-described description can also be expressed as below.

According to a first aspect, there is provided a coil component including a main body portion including an element body having insulating properties, a coil disposed inside the element body, a first conductor layer electrically connected to one end side of the coil, and a second conductor layer electrically connected to another end side of the coil. The main body portion has a substantially rectangular parallelepiped shape, and has a bottom surface for mounting, a top surface located away from the bottom surface in a height direction orthogonal to the bottom surface of the main body portion, a pair of end surfaces located away from each other in a first direction orthogonal to the height direction, a pair of side surfaces located away from each other in a second direction orthogonal to the height direction and the first direction, a first ridge portion between the top surface and one of the pair of end surfaces, a second ridge portion between one of the pair of side surfaces and one of the pair of end surfaces, and a third ridge portion between the top surface and one of the pair of side surfaces. The first conductor layer is exposed on part of the bottom surface of the main body portion and on at least part of a first end surface of the pair of end surfaces, the second conductor layer is exposed on part of the bottom surface of the main body portion and on at least part of a second end surface of the pair of end surfaces, each of the first ridge portion, the second ridge portion, and the third ridge portion is formed from a curved surface rounded to be curved in a projecting shape, and the first ridge portion has a radius of curvature R1 that is larger than a radius of curvature R2 of the second ridge portion and a radius of curvature R3 of the third ridge portion.

According to a second aspect, in the coil component according to the first aspect, the radius of curvature R1 of the first ridge portion and the radius of curvature R2 of the second ridge portion satisfy R1/R2≥2.

According to a third aspect, in the coil component according to the first aspect, the radius of curvature R1 of the first ridge portion and the radius of curvature R3 of the third ridge portion satisfy R1/R3≥2.

According to a fourth aspect, in the coil component according to the first aspect, the radius of curvature R1 of the first ridge portion, the radius of curvature R2 of the second ridge portion, and the radius of curvature R3 of the third ridge portion satisfy R1/R2≥2 and R1/R3≥2.

According to a fifth aspect, in the coil component according to any one of the first to the fourth aspects, the radius of curvature R2 of the second ridge portion and the radius of curvature R3 of the third ridge portion are configured to be same.

According to a sixth aspect, in the coil component according to any one of the first to the fourth aspects, the radius of curvature R3 of the third ridge portion is larger than the radius of curvature R2 of the second ridge portion.

According to a seventh aspect, the coil component according to the sixth aspect further includes a first electrode layer that covers portions of the first conductor layer exposed on the first end surface and on the bottom surface of the main body portion; and a second electrode layer that covers portions of the second conductor layer exposed on the second end surface and on the bottom surface of the main body portion.

According to an eighth aspect, in the coil component according to any one of the first to the fourth aspects, the radius of curvature R2 of the second ridge portion is larger than the radius of curvature R3 of the third ridge portion.

According to a ninth aspect, in the coil component according to any one of the first to the eighth aspects, the main body portion further has a fourth ridge portion between the bottom surface and one of the pair of end surfaces, the fourth ridge portion being formed from a curved surface rounded to be curved in a projecting shape, and the fourth ridge portion has a radius of curvature R4 that is smaller than the radius of curvature R1 of the first ridge portion, the radius of curvature R2 of the second ridge portion, and the radius of curvature R3 of the third ridge portion.

According to a tenth aspect, in the coil component according to the ninth aspect, the first conductor layer constitutes at least part of the fourth ridge portion between the first end surface and the bottom surface, and the second conductor layer constitutes at least part of the fourth ridge portion between the second end surface and the bottom surface.

According to an eleventh aspect, in the coil component according to any one of the first to the tenth aspects, the coil includes a plurality of coil wiring layers stacked in an axial direction of the coil, and a via conductor that electrically connects two of the coil wiring layers adjacent to each other in the axial direction.

According to a twelfth aspect, in the coil component according to any one of the first to the fourth aspects, the coil includes a plurality of coil wiring layers stacked in an axial direction of the coil, and a via conductor that electrically connects two of the coil wiring layers adjacent to each other in the axial direction, the axial direction is orthogonal to the top surface, and the radius of curvature R2 of the second ridge portion is larger than the radius of curvature R3 of the third ridge portion.

According to a thirteenth aspect, in the coil component according to any one of the first to the fourth aspects, the coil includes a plurality of coil wiring layers stacked in an axial direction of the coil, and a via conductor that electrically connects two of the coil wiring layers adjacent to each other in the axial direction, the axial direction is orthogonal to the pair of side surfaces, and the radius of curvature R2 of the second ridge portion is larger than the radius of curvature R3 of the third ridge portion.

Since the coil component of the present disclosure has highly insulating properties between coil wiring layers, the coil component is used as, for example, an impedance matching coil (matching coil) of a high-frequency circuit and is used for electronic devices such as a personal computer, a DVD player, a digital camera, a TV, a mobile phone, automotive electronics, and medical and industrial machinery. The coil component of the present disclosure can also be suitably used for a tuning circuit, a filter circuit, a rectification smoothing circuit, or the like.

What is claimed is:

1. A coil component comprising:
a main body portion including
an element body having insulating properties,
a coil inside the element body,
a first conductor layer electrically connected to one end side of the coil, and
a second conductor layer electrically connected to another end side of the coil, wherein
the main body portion has a substantially rectangular parallelepiped shape, and has
a bottom surface for mounting,
a top surface spaced from the bottom surface in a height direction orthogonal to the bottom surface of the main body portion,
a pair of end surfaces spaced from each other in a first direction orthogonal to the height direction,
a pair of side surfaces spaced from each other in a second direction orthogonal to the height direction and the first direction,
a first ridge portion between the top surface and one of the pair of end surfaces,
a second ridge portion between one of the pair of side surfaces and one of the pair of end surfaces, and
a third ridge portion between the top surface and one of the pair of side surfaces,
the first conductor layer is exposed on part of the bottom surface of the main body portion and on at least part of a first end surface of the pair of end surfaces of the main body portion,
the second conductor layer is exposed on part of the bottom surface of the main body portion and on at least part of a second end surface of the pair of end surfaces of the main body portion,
each of the first ridge portion, the second ridge portion, and the third ridge portion defines a curved surface that is rounded to curve in a projecting shape, and
the first ridge portion has a radius of curvature R1 that is larger than a radius of curvature R2 of the second ridge portion and a radius of curvature R3 of the third ridge portion.

2. The coil component according to claim 1, wherein
the radius of curvature R1 of the first ridge portion and the radius of curvature R2 of the second ridge portion satisfy R1/R2≥2.

3. The coil component according to claim 1, wherein
the radius of curvature R1 of the first ridge portion and the radius of curvature R3 of the third ridge portion satisfy R1/R3≥2.

4. The coil component according to claim 1, wherein
the radius of curvature R1 of the first ridge portion, the radius of curvature R2 of the second ridge portion, and the radius of curvature R3 of the third ridge portion satisfy R1/R2≥2 and R1/R3≥2.

5. The coil component according to claim 1, wherein
the radius of curvature R2 of the second ridge portion and the radius of curvature R3 of the third ridge portion are configured to be the same.

6. The coil component according to claim 1, wherein
the radius of curvature R3 of the third ridge portion is larger than the radius of curvature R2 of the second ridge portion.

7. The coil component according to claim 6, further comprising:
a first electrode layer that covers portions of the first conductor layer exposed on the first end surface and on the bottom surface of the main body portion; and
a second electrode layer that covers portions of the second conductor layer exposed on the second end surface and on the bottom surface of the main body portion.

8. The coil component according to claim 1, wherein
the radius of curvature R2 of the second ridge portion is larger than the radius of curvature R3 of the third ridge portion.

9. The coil component according to claim 1, wherein
the main body portion further has a fourth ridge portion between the bottom surface and one of the pair of end surfaces, the fourth ridge portion defining a curved surface rounded to be curved in a projecting shape, and
the fourth ridge portion has a radius of curvature R4 that is smaller than the radius of curvature R1 of the first ridge portion, the radius of curvature R2 of the second ridge portion, and the radius of curvature R3 of the third ridge portion.

10. The coil component according to claim 9, wherein
the first conductor layer configures at least part of the fourth ridge portion between the first end surface and the bottom surface, and
the second conductor layer configures at least part of the fourth ridge portion between the second end surface and the bottom surface.

11. The coil component according to claim 1, wherein
the coil includes a plurality of coil wiring layers stacked in an axial direction of the coil, and a via conductor that electrically connects two of the coil wiring layers adjacent to each other in the axial direction.

12. The coil component according to claim 11, wherein
the axial direction is orthogonal to the top surface, and
the radius of curvature R2 of the second ridge portion is larger than the radius of curvature R3 of the third ridge portion.

13. The coil component according to claim 11, wherein
the axial direction is orthogonal to the pair of side surfaces, and
the radius of curvature R2 of the second ridge portion is larger than the radius of curvature R3 of the third ridge portion.

14. The coil component according to claim 2, wherein
the radius of curvature R2 of the second ridge portion and the radius of curvature R3 of the third ridge portion are configured to be the same.

15. The coil component according to claim 3, wherein
the radius of curvature R2 of the second ridge portion and the radius of curvature R3 of the third ridge portion are configured to be the same.

16. The coil component according to claim 2, wherein
the radius of curvature R3 of the third ridge portion is larger than the radius of curvature R2 of the second ridge portion.

17. The coil component according to claim 3, wherein
the radius of curvature R3 of the third ridge portion is larger than the radius of curvature R2 of the second ridge portion.

18. The coil component according to claim 2, wherein
the radius of curvature R2 of the second ridge portion is larger than the radius of curvature R3 of the third ridge portion.

19. The coil component according to claim 2, wherein
the main body portion further has a fourth ridge portion between the bottom surface and one of the pair of end surfaces, the fourth ridge portion defining a curved surface rounded to be curved in a projecting shape, and
the fourth ridge portion has a radius of curvature R4 that is smaller than the radius of curvature R1 of the first ridge portion, the radius of curvature R2 of the second ridge portion, and the radius of curvature R3 of the third ridge portion.

20. The coil component according to claim 2, wherein
the coil includes a plurality of coil wiring layers stacked in an axial direction of the coil, and a via conductor that electrically connects two of the coil wiring layers adjacent to each other in the axial direction.
